(19) United States
(12) Patent Application Publication
(10) Pub. No.: US 2026/0324672 A1
(43) Pub. Date: Oct. 22, 2026

(54) METHODS OF MAKING CHEWABLE GUMMIES FROM TWO DIFFERENT FRUCTO-OLIGOSACCHARIDES AND CHEWABLE GUMMIES INCLUDING THE SAME

(71) Applicant: Ion Labs, Inc., Largo, FL (US)

(72) Inventors: Patrick W. Wilson, Pinellas Park, FL (US); Wesley F. Barton, Holiday, FL (US)

(73) Assignee: Ion Labs, Inc., Largo, FL (US)

(21) Appl. No.: 19/721,447

(22) Filed: Jun. 26, 2026

Related U.S. Application Data
(62) Division of application No. 18/619,732, filed on Mar. 28, 2024.
(60) Provisional application No. 63/492,626, filed on Mar. 28, 2023.

(51) Int. Cl. A23G 3/48; A23G 3/42

(52) U.S. Cl. CPC A23G 3/48; A23G 3/42

(57) ABSTRACT

Chewable gummies and methods of making chewable gummies that include combining liquid fructo-oligosaccharide, powder fructo-oligosaccharide, gelling agent, and water to form a gummy composition, and allowing the composition to set to form a chewable gummy.

### CROSS REFERENCE TO RELATED APPLICATIONS

This application is a divisional application of U.S. application Ser. No. 18/619,732, filed Mar. 28, 2024, and claims the benefit of U.S. Provisional Application Ser. No. 63/492,626, filed on Mar. 28, 2023, both of which are incorporated herein.

### BACKGROUND

The invention is directed to forming chewable gummies from two different fructo-oligosaccharides.

The term “Gummy” is often used to describe a class of chewable nutritional supplements that have a gum-like or rubber-like texture. Gummies are typically made from a gelling agent, sugar, syrup, flavor, color agent, and water. The most common gelling agents used in gummies are gelatin, agar, and pectin. Other gelling agents such as gum Arabic and carrageenan have been used in combinations with the more typical gelling agents to modify the visual and textural characteristics of the gummy composition.

Gelatin is a protein derived from collagen, primarily bovine or porcine in origin. Gelatin is unsuitable for consumers who seek to maintain a vegetarian or vegan diet. Gummies made from gelatin also are thermally unstable and tend to melt at elevated temperatures (e.g., in hot storage areas or during transport).

Agar (also referred to as agar agar) is a galactose polymer extracted from red algae.

Pectin is a heteropolysaccharide gelling agent that includes chains of α-1,4-D-galacturonic acid. Pectin is obtained from fruit, typically by extraction of citrus peels or apple pomace. Pectin is available in a variety of forms including, e.g., low methoxy pectin and high methoxy pectin. Low methoxy pectin can gel in the presence of ions such as calcium and potassium. Low methoxy pectin is often supplied in a powder form. High methoxy pectin can crosslink in the presence of acid. High methoxy pectin is often supplied in the form of a powder as a mixture of high methoxy pectin and simple sugar (e.g., monosaccharides and disaccharides) or maltodextrin. The simple sugar is used to provide a standardized measure of the gel strength of a pectin. The simple sugars in pectin function to help solubilize the pectin in water. A buffering agent such as sodium citrate and citric acid is sometimes present in commercial sources of pectin.

Pectin is heat sensitive. Pectin can degrade if exposed to high temperatures for prolonged periods of time during manufacturing, which can result in poor gel formation.

Traditional chewable gummies often include a high level of (e.g., about 80% by weight) simple sugar. The source of simple sugar in the chewable gummies is often sugar syrups that are added to the composition during manufacturing. Such sugar syrups include glucose syrups and corn syrups, which contain high levels of simple sugars such as sucrose and glucose. Sucrose and glucose are simple mono- and di-saccharides with high glycemic index (GI) value. Sucrose has a GI value of 63 and glucose has GI value of 100. These sugars can lead to a spike in glucose levels when ingested and are not well tolerated by the portion of the population that is either diabetic or has a diabetic tendency.

Non-sugar sweeteners such as sugar alcohols (e.g., erythritol, lactitol, maltitol, sorbitol, xylitol, isomalt and mannitol) have been used to reduce the amount of sugar present in gummies. Sugar alcohols are not digestible, or are poorly absorbed, by the body. Sugar alcohols can lead to gastric distress, bloating, gas, or diarrhea. Sugar alcohols also tend to have an unnatural sweet taste.

Water is used in gummy compositions. When manufacturing chewable gummies, excess water is driven off, typically by heat. If the composition is exposed to the heat for too long or if the temperature is too high, the components of the composition can degrade.

There is a need for chewable gummies that are thermally stable, have increased dietary fiber content, are relatively low in simple sugar content, and can be manufactured on a commercial scale. There is also a need for such chewable gummies that are also suitable for a vegetarian diet.

### SUMMARY

In one aspect, the invention features a method of making a chewable gummy that utilizes at least two different fructo-oligosaccharides, one in liquid form and one in powder form. In one embodiment, the method of making a chewable gummy includes forming a gummy composition by combining liquid fructo-oligosaccharide having a Brix of at least 25%, powder fructo-oligosaccharide, pectin, water, and food acid, and allowing the gummy composition to set to form a chewable gummy. In one embodiment, the liquid fructo-oligosaccharide has a first average degree of polymerization, the powder fructo-oligosaccharide has a second average degree of polymerization, the second average degree of polymerization being greater than the first average degree of polymerization.

In some embodiments, the method further includes combining a first portion of the powdered fructo-oligosaccharide and the pectin, mixing the powdered fructo-oligosaccharide and the pectin to form a first uniform mixture, combining the first uniform mixture and water to form an aqueous composition, and subsequently adding the liquid fructo-oligosaccharide to the aqueous composition. In one embodiment, the method further includes combining, with mixing, a second portion of the powder fructo-oligosaccharide and the liquid fructo-oligosaccharide prior to the step of adding the liquid fructo-oligosaccharide to the aqueous composition.

In other embodiments, the method further includes combining the water and the liquid fructo-oligosaccharide to form a first composition, adding the powdered fructo-oligosaccharide to the first composition to form a second composition, homogenizing the second composition to form a homogenized liquid, and subsequently adding pectin to the homogenized liquid.

In another embodiment, the combining includes combining a percent by weight of the powder fructo-oligosaccharide that is greater than the percent by weight of the liquid fructo-oligosaccharide.

In one embodiment, the ratio of the powder fructo-oligosaccharide to the liquid fructo-oligosaccharide is from 50:50 to 65:35. In some embodiments, the ratio of the powder fructo-oligosaccharide to the liquid fructo-oligosaccharide is from 55:45 to 60:40.

In some embodiments, the composition further includes fruit juice concentrate. In one embodiment, the fruit juice concentrate includes a lemon fruit juice concentrate, a pomegranate fruit juice concentrate, blueberry juice concentrate, or a combination thereof.

In another embodiment, the resulting chewable gummy includes greater than 20% by weight dietary fiber.

In other embodiments, the chewable gummy includes less than 500 mg sugar selected from the group consisting of monosaccharides, disaccharides, and combinations thereof. In some embodiments, the chewable gummy includes less than 250 mg sugar selected from the group consisting of monosaccharides, disaccharides, and combinations thereof.

In another embodiment, the gummy composition includes from 10% by weight to 90% by weight of the liquid fructo-oligosaccharides, and from 10% by weight to 90% by weight of the powder fructo-oligosaccharides.

In another embodiment, the gummy composition includes from 10% by weight to 80% by weight of the liquid fructo-oligosaccharides, from 10% by weight to 80% by weight of the powder fructo-oligosaccharides, and from 1% by weight to 5% by weight of the pectin.

In other embodiments, the gummy composition includes from 10% by weight to 80% by weight of the liquid fructo-oligosaccharides, from 10% by weight to 80% by weight of the powder fructo-oligosaccharides, from 1% by weight to 5% by weight of the pectin, and from 1% by weight to 8% by weight of the food acid.

In some embodiments, the mode degree of polymerization of the liquid fructo-oligosaccharide is less than the mode degree of polymerization of the powder fructo-oligosaccharide.

In one embodiment, the liquid fructo-oligosaccharide has a Brix of at least 60%. In another embodiment, the liquid fructo-oligosaccharide has a Brix of at least 70%.

In another aspect, the invention features a chewable gummy made according to a method disclosed above or herein.

In other aspects, the invention features a chewable gummy that includes first fructo-oligosaccharide, second fructo-oligosaccharide, first fructo-oligosaccharide differing from the second fructo-oligosaccharide based on a property selected form the group consisting of average degree of polymerization, mode degree of polymerization, mode molecular weight, and combinations thereof, pectin, and food acid. In one embodiment, the first fructo-oligosaccharide has an average degree of polymerization no greater than 10, and the second fructo-oligosaccharide has an average degree of polymerization no greater than 20. In other embodiments, the fructo-oligosaccharides in the chewable gummy exhibit a bimodal molecular weight distribution, a bimodal degree of polymerization distribution, or a combination thereof. In some embodiments, the first fructo-oligosaccharide has a mode degree of polymerization that is greater than the mode degree of polymerization of the second fructo-oligosaccharide. In another embodiment, the chewable gummy includes from 10% by weight to 80% by weight of the first fructo-oligosaccharide, from 10% by weight to 80% by weight of the second fructo-oligosaccharide, from 1% by weight to 5% by weight of the pectin. In one embodiment, the ratio of the first fructo-oligosaccharide to the second fructo-oligosaccharide in the chewable gummy is from 50:50 to 65:35. In some embodiments, the chewable gummy includes less than 500 mg sugar selected from the group consisting of monosaccharides, disaccharides, and combinations thereof. In another embodiment, the chewable gummy includes from 50% by weight to 90% by weight fructo-oligosaccharides, and from 1% by weight to 5% by weight pectin. In other embodiments, the chewable gummy includes from 75% by weight to 90% by weight fructo-oligosaccharides. In one embodiment, the first and second fructo-oligosaccharides contribute at least 20% by weight dietary fiber to the chewable gummy.

In one aspect, the invention features a chewable gummy that includes fructo-oligosaccharides having an average degree of polymerization no greater than 20 and a mode degree of polymerization no greater than 20, pectin; and food acid, the fructo-oligo saccharides contributing at least 20% by weight dietary fiber to the chewable gummy. In one embodiment, the fructo-oligosaccharides have an average degree of polymerization no greater than 11 and a mode degree of polymerization no greater than 11.

In another aspect, the invention features a chewable gummy derived from a composition that includes first fructo-oligosaccharide, second fructo-oligosaccharide, the first fructo-oligosaccharide differing from the second fructo-oligosaccharide by a property selected from the group consisting of physical state, average degree of polymerization, mode degree of polymerization, mode molecular weight, and combinations thereof; gelling agent, water, the chewable gummy including at least 20% by weight dietary fiber contributed by the first and second fructo-oligosaccharides.

The invention features a method that enables a gummy composition to be processed at relatively high temperatures for a period of time that is sufficiently short so as to be suitable for maintaining the integrity of pectin. The resulting chewable gummies exhibit desirable organoleptic properties, good thermal stability, and a relatively high dietary fiber content resulting from the fructo-oligosaccharide content.

The invention also features some chewable gummies that have less than 500 milligrams of sugar per serving and can be labeled “sugar free” under United States federal laws governing food labeling.

Other features and advantages will be apparent from the following description of the preferred embodiments and from the claims.

### GLOSSARY

In reference to the invention, these terms have the meanings set forth below:

The term “sugar free” means less than 500 mg of added monosaccharides and disaccharides per chewable gummy.

The phase “added monosaccharides and disaccharides” means neat monosaccharides and disaccharides that are added to the gummy composition from a source other than the gelling agent, the fructo-oligosaccharides, and fruit juice.

The phase “mode degree of polymerization” means the degree of polymerization that occurs most often in a mixture of fructo-oligosaccharides having a degree of polymerization distribution.

The phrase “a mode molecular weight” means the molecular weight that occurs most often in a mixture of fructo-oligosaccharides having a molecular weight distribution.

The phrase “bimodal degree of polymerization distribution” means the presence of two modes of degree of polymerization in a mixture of fructo-oligosaccharides.

### DETAILED DESCRIPTION

The method of making chewable gummies includes forming a gummy composition by combining powder fructo-oligosaccharide, liquid fructo-oligosaccharide, and gelling agent such as pectin, dissolving the same in water to form a gummy composition, removing the water from the composition (e.g., through heating and optionally applying a vacuum), optionally acidifying the gummy composition, transferring the gummy composition to a mold, and allowing the gummy composition to set to a chewable gummy. The powder fructo-oligosaccharide includes a mixture of polydisperse fructo-oligosaccharides (i.e., fructo-oligosaccharides having different molecular weights or degrees of polymerization). The liquid fructo-oligosaccharide includes a mixture of polydisperse fructo-oligosaccharides.

The chewable gummy includes a first fructo-oligosaccharide, a second fructo-oligosaccharide, a gelling agent, and water. The chewable gummy preferably includes a combination of at least two different mixtures of polydisperse fructo-oligosaccharides such that the fructo-oligosaccharides in the chewable gummy exhibit at least one of a bimodal degree of polymerization distribution (i.e., a first mode degree of polymerization and a second mode degree of polymerization that is greater than the first mode degree of polymerization), a multimodal degree of polymerization distribution (i.e., greater than two modes of degree of polymerization), a bimodal molecular weight distribution (i.e., a first mode molecular weight and a second mode molecular weight that is greater than the first mode molecular weight), a multimodal molecular weight distribution (i.e., greater than two modes of molecular weight distribution), a first average degree of polymerization (DP) that is greater than a second average DP, and combinations thereof.

The chewable gummy preferably includes at least 10% by weight, at least 20% by weight, at least 30% by weight, at least 40% by weight, at least 45% by weight, at least 50% by weight, at least 55% by weight, at least 60% by weight, no greater than 80% by weight, no greater than 75% by weight, from 20% by weight to 80% by weight, from 25% by weight to 80% by weight, from 30% by weight to 75% by weight, from 50% by weight to 75% by weight, or even from 60% by weight to 75% by weight dietary fiber.

### Fructo-Oligosaccharides

The fructo-oligosaccharides include linear chains of at least two β-(2→1)-glycosidic linked fructose units and a β-(2→1) glycosidic-linked glucose where at least 75% of the glycosidic linkages are β-(2→1), linear chains of at least three fructose units linked together by a glycosidic linkage, preferably a β-(2→1) glycosidic linkage, and combinations thereof. One useful source from which the fructo-oligosaccharides are derived is inulin (e.g., chicory root inulin, agave inulin, and combinations thereof, preferably chicory root inulin). Useful fructo-oligosaccharides can also be synthesized from fructose molecules.

The gummy composition and the chewable gummy preferably include at least 50% by weight, no greater than 90% by weight, from 70% by weight to 90% by weight, or even from 80% by weight to 90% by weight fructo-oligosaccharide.

The fructo-oligosaccharides provide dietary fiber to the chewable gummy. The chewable gummy preferably includes at least 10% by weight, at least 20% by weight, at least 30% by weight, at least 40% by weight, at least 45% by weight, at least 50% by weight, at least 55% by weight, at least 60% by weight, no greater than 80% by weight, no greater than 75% by weight, from 20% by weight to 80% by weight, from 25% by weight to 80% by weight, from 30% by weight to 75% by weight, from 50% by weight to 75% by weight, or even from 60% by weight to 75% by weight dietary fiber contributed by the fructo-oligosaccharides.

The first fructo-oligosaccharide and the second fructo-oligosaccharide differ from each other in at least one property including, e.g., physical state (e.g., powder and liquid), average DP, mode DP, weight average molecular weight, mode molecular weight, and combinations thereof. The chewable gummy preferably includes a first mixture of polydisperse fructo-oligosaccharide having a mode molecular weight of no greater than 1500, from 500 to 1500, or even from 540 to 1500, and a second mixture of polydisperse fructo-oligosaccharide having a mode molecular weight of greater than 1800, from 2000 to 3500, or even from 2300 to 3100.

The chewable gummy preferably is derived from mixtures of polydisperse fructo-oligosaccharides having different physical states. In one useful fructo-oligosaccharide combination, one of the first and second fructo-oligosaccharides is added to the gummy composition in the form of a powder and the other of the first and second fructo-oligosaccharides is added to the gummy composition in the form of a liquid. Useful powder forms of fructo-oligosaccharides have a particle size, as determined according to US Mesh size, where at least 100% of the particles are no larger than 4 Mesh, no larger than 12 Mesh, or even no larger 20 Mesh, and at least 80% of the particles are no larger than 80 Mesh, or even no larger than 100 Mesh. Useful liquid forms of fructo-oligosaccharide have a Brix of at least 25%, at least 50%, at least 65%, at least 70%, at least 72%, or even at least 75%.

The weight-to-weight ratio of the powder fructo-oligosaccharide to the liquid fructo-oligosaccharide preferably is from 50:50 to 65:35, from 50:50 to 60:40 or even from 55:45 to 60:40.

Preferably the gummy composition and the chewable gummy includes at least 10% by weight, no greater than 80% by weight, from 20% by weight to 70% by weight, or even from 30% by weight to 60% by weight powder fructo-oligosaccharide, and at least 10% by weight, no greater than 80% by weight, from 20% by weight to 70% by weight, or even from 30% by weight to 60% by weight liquid fructo-oligosaccharide.

Where one of the differences between the first and second fructo-oligosaccharides is the mode DP, one of the mixtures of polydisperse fructo-oligosaccharides has a mode DP that is relatively smaller than the mode DP of the other mixture of polydisperse fructo-oligosaccharides such that the fructo-oligosaccharides in the gummy composition are bimodal. Preferably the gummy composition and the chewable gummy includes from at least 10% by weight, no greater than 80% by weight, from 20% by weight to 70% by weight, or even from 30% by weight to 60% by weight of a first mixture of polydisperse fructo-oligosaccharides, and at least 10% by weight, no greater than 80% by weight, from 20% by weight to 70% by weight, or even from 30% by weight to 60% by weight of a second mixture of polydisperse fructo-oligosaccharides where the mode DP of the first mixture of fructo-oligosaccharides is smaller than the mode DP of the second mixture of fructo-oligosaccharides.

One useful combination of first and second fructo-oligosaccharides includes a combination of fructo-oligosaccharides having a mode DP of from 2 to 10, and a fructo-oligosaccharides having a mode DP of from greater than 10 to 60, or even from 11 to 20.

Where one of the differences between the first and second mixtures of fructo-oligosaccharides is the average DP, one of the mixtures of polydisperse fructo-oligosaccharides has an average DP that is relatively smaller than the average DP of the other mixture of polydisperse fructo-oligosaccharides such that the gummy composition is derived from relatively shorter chain oligosaccharides and relatively longer chain oligosaccharides.

Preferably the relatively shorter chain fructo-oligosaccharides have an average DP of no greater than 11, no greater than 10, from 2 to 11, from 2 to 10, from 3 to 9, or even from 3 to 6. Preferably the relatively longer chain fructo-oligosaccharides have an average DP greater than 5, from 6 to 20, from 6 to 18, or even from 6 to 17. The relatively shorter chain fructo-oligosaccharides can be in the form of a powder or a liquid. The relatively longer chain fructo-oligosaccharides can be in the form of a powder or a liquid.

Preferably the ratio of relatively longer chain fructo-oligosaccharide to the relatively shorter chain fructo-oligosaccharide is from 50:50 to 65:35, from 50:50 to 60:40 or even from 55:45 to 60:40.

Preferably the gummy composition and the chewable gummy includes from at least 10% by weight, no greater than 80% by weight, from 20% by weight to 70% by weight, or even from 30% by weight to 60% by weight relatively shorter chain fructo-oligosaccharides, and at least 10% by weight, no greater than 80% by weight, from 20% by weight to 70% by weight, or even from 30% by weight to 60% by weight relatively longer chain fructo-oligosaccharides.

Useful commercially available powder fructo-oligosaccharides include, e.g., powder fructo-oligosaccharides available under the FRUTAFIT and FRUTALOSE series of trade designations from Sensus B.V. Besloten Vennootschap (Netherlands) including FRUTAFIT CLR having an average chain length of 7 to 9 monomers and FRUTALOSE SFP having a DP from 2 to 10, and under the ORFATI series of trade designations from Beneo GmbH (Mannheim, Germany), and powder fructo-oligosaccharides available from Baolingbao Biotechnology Co., Ltd. (Yucheng Shandong, China) including fructo-oligosaccharide 95 powder.

Useful commercially available liquid fructo-oligosaccharides are commercially available under a variety of trade designations including, e.g., under the FRUTALOSE series of trade designations from Sensus B.V. Besloten Vennootschap (Netherlands) including FRUTALOSE L85 liquid oligofructose having a DP no greater than 10, FRUTALOSE L90 liquid oligofructose having a DP from 2 to 10, FRUTALOSE L92 liquid oligofructose, and FRUTALOSE SF75 liquid oligofructose having a DP of from 2 to 10, under the ORAFTI series of trade designations from Raffinerie Tirlemontoise S.A. (Belgium), and under the FIBRULOSE and FIBRULINE series of trade designations from Cosucra Groupe Warcoing S.A. (Belgium).

### Gelling Agent

Useful gelling agents for the gummy composition include, e.g., pectin, gelatin, agar agar, carrageenan, gellan gum, and combinations thereof. Commercially available gelling agents often include additional components including, e.g., buffering agents, carbohydrates (e.g., simple sugars (e.g., sucrose)), calcium, acid, and combinations thereof. The gummy composition and the chewable gummies preferably include from 1% by weight to 20% by weight, from 1% by weight to 15% by weight, from 1% by weight to 5% by weight, from 1.5% by weight to 4.5% by weight, or even from 2.5% by weight to 4% by weight gelling agent.

A preferred gelling agent is pectin. Pectin is a heteropolysaccharide that includes chains of galacturonic acid. Pectin is a particularly useful gelling agent. Useful pectins also include high-methoxy pectins in which greater than 50% of the carboxyl groups present on the pectin are esterified with methanol (i.e., methyl esters), low-methoxy pectins in which from 5% to 50% of the carboxyl groups present on the pectin are esterified with methanol, and combinations thereof. Useful pectins include pectins that gel at low pH in the presence of sugars, pectins that gel in the presence of divalent cations, and combinations thereof.

Gummy compositions that are formulated with high-methoxy pectin preferably include a buffering system (e.g., sodium citrate), an acid source (e.g., citric acid), and optionally a carbohydrate source in addition to the fructo-oligosaccharides. Gummy compositions that are formulated with low-methoxy pectin optionally include divalent or trivalent cations that function as gelling agents (e.g., crosslinking agents) including such cations as calcium (Ca⁺²), magnesium (Mg⁺²), iron (Fe⁺²), Zinc (Zn⁺²), and barium (Ba⁺²), and combinations thereof. Useful sources of ions include food-grade compounds that contain the ions. Suitable sources of calcium include calcium lactate, calcium gluconate, calcium chloride, and combinations thereof.

Useful pectins are commercially available under a variety of trade designations including, e.g., under the GRINDSTED series of trade designations from International Flavors and Fragrances Inc. (New York, New York) including GRINDSTED PECTIN CF 140 B PRM pectin having a gel strength of from 200-265, pH from 5.2 to 5.8, a degree of esterification of about 60%, and a particle size of a 2% maximum greater than 60 mesh, all properties as reported by the manufacturer, under the GENU series of trade designations from CP Kelco U.S. a Huber Company (Atlanta, Georgia) including GENU Pectin D Slow Set citrus pectin having a degree of esterification not specified but typically 64% as reported by the manufacturer, and under the PECTNER series of trade designations from Yantai DSM Andre Pectin Co, Ltd (Yantai, China).

When pectin is present in the gummy composition, the gummy composition and the chewable gummy preferably includes at least 1% by weight, from 1% by weight to 5% by weight, from 1.5% by weight to 4.5% by weight, or even from 2.5% by weight to 4% by weight pectin, and optionally includes pectin in combination with at least one other gelling agent, in the amounts set forth above, to achieve a total amount of gelling agent in the amounts set forth above with respect to gelling agents in general.

When gelatin is present in the gummy composition, the gummy composition and the chewable gummy preferably includes at least 1% by weight, from 1% by weight to 20% by weight, from 1% by weight to 15% by weight, from 2% by weight to 12% by weight, or even from 2% to 7% by weight, and optionally includes gelatin in combination with at least one other gelling agent, in the amounts set forth above, to achieve a total amount of gelling agent in the amounts set forth above with respect to gelling agents in general.

### Food Acid

The gummy composition preferably also is formulated with at least one food acid, i.e., a food-grade organic acid. Useful food acids include, e.g., acetic acid, adipic acid, ascorbic acid, aspartic acid, butyric acid, citric acid, formic acid, fumaric acid, hexamic acid, lactic acid, malic acid, oxalic acid, propionic acid, sorbic acid, succinic acid, sodium acid pyrophosphate, tartaric acid, amino acid hydrochlorides, and acid salts and acid anhydrides thereof, and combinations thereof. For gummy compositions derived from high methoxy pectin, the gummy composition includes an acid. The source of the acid can be any suitable acid source including, e.g., organic acid, a concentrated acidic fruit juice such as lemon juice concentrate, and combinations thereof.

The gummy composition includes, and the chewable gummy optionally is derived from, from 0% by weight to 10% by weight, from 0.5% by to 10% by weight, from 0.5% by to 8% by weight, from 1% by weight to 6% by weight, or even from 2% by weight to 5% by weight food acid.

### Fruit Juice Concentrate

The gummy composition optionally includes fruit juice concentrate. Any sugar present in the fruit juice concentrate optionally aids in solubilizing the pectin and any acid present in the fruit juice concentrate optionally aids in crosslinking the pectin. The fruit juice concentrate can impart sweetness, color, flavor, or a combination thereof, to the chewable gummy composition. Useful fruit juice concentrates include concentrated juice from a variety of fruits including, e.g., lemons, apples, grapes, strawberries, raspberries, blueberries, kiwis, pears, peaches, pomegranates, prickly pear, dragon fruit, pineapple, orange, and combinations thereof.

The gummy composition optionally includes, and the chewable gummy optionally is derived from, from 0% by weight to 15% by weight, from 1% by to 15% by weight, from 3% by weight to 10% by weight, or even from 5% by weight to 8% by weight fruit juice concentrate.

### Water

The gummy composition is formulated with a suitable amount of water (e.g., purified water, deionized water, and combinations thereof).

### Optional Ingredients

The gummy composition optionally includes a variety of other ingredients including, e.g., flavor agents, flavor masking agents, color agents, active agents, mono and di saccharides, sugar alcohols, sugar free sweeteners, starches, buffering salts, oils, emulsifiers, and combinations thereof.

The flavor agent can be used to impart any desired flavor to the gummy composition including, e.g., lemon (e.g., lemonade), lime, orange, mango-orange, citrus orange, grape, tropical punch, citrus lime, citrus fruit, grapefruit, apple, pear, peach, grape, strawberry, raspberry, cherry, plum, pineapple, apricot, guava, mango, papaya, watermelon, musk melon, pineapple, grapefruit, blueberry, pomegranate, blackberry, tri-berry, ginger, tangerine, cantaloupe, tea, mint, cinnamon, menthol, cocoa, vanilla, almond, coffee, and combinations thereof (e.g., multiple berry flavors, watermelon-lemonade, strawberry-lemonade, lemon-lime, cherry-limeade, and combinations thereof). Useful flavor agents include liquid flavor agents, e.g., oil-based flavor agents, water-based flavor agents, and combinations thereof.

Flavor masking agents (“maskers”) that function to mask “off notes” in a composition. Such off notes include, e.g., bitter, fishy, metallic, beany, earthy, and sour tastes, which are referred to as “notes.” Such notes can be imparted by another agent in the composition including, e.g., active agents, extracts, and other agents that are present in the composition. Maskers can be in a variety of forms including, e.g., liquids and powders.

Useful color agents include, e.g., food, drug and cosmetic (FD&C) colors including, e.g., dyes, pigments, lakes, natural colorants, and derived colorants. Useful naturally derived color agents include color agents derived from riboflavin, spirulina, vegetables (e.g., black carrot, orange carrot extract, beta-carotene, beet root, yellow beet root, and combinations thereof), annatto, turmeric, fruits (e.g., purple berry), and combinations thereof. Useful lakes include dyes absorbed on aluminum hydroxide and other suitable carriers. Examples of suitable colors include FD&C Red No. 3, FD&C Red No. 40, FD&C Blue No. 1, FD&C Blue No. 2, FD&C Yellow No. 5, FD&C Yellow No. 6, FD&C Green No. 3, and combinations thereof.

Active agents that are optionally present in the gummy composition include, e.g., medicaments (e.g., pharmaceuticals and over the counter drugs), vitamins, minerals, antioxidants, amino acids, digestive enzymes, bioflavonoids, botanicals, Coenzyme Q10, probiotics, other dietary supplements, herbs, and combinations thereof. Examples of useful vitamins include, e.g., ascorbic acid (vitamin C), aspartic acid, nicotinic acid, pantothenic acid, pyridoxine, biotin, folic acid, lipoic acid, Vitamin A (beta carotene), vitamin B complex, vitamin B1 (thiamine), vitamin B2 (Riboflavin), Vitamin B3 (Niacin), Vitamin B3 (Niacin), Vitamin B5 (Pantothenic Acid), Vitamin B6 (Pyridoxine), vitamin B12 (cyanocobalamin), vitamin D, vitamin E and vitamin K and coenzymes thereof, choline, carnitine, and alpha, beta, and gamma carotenes, inositol, para-aminobenzoic acid, and combinations thereof.

Examples of useful minerals include iron, zinc, calcium, chromium, sodium, potassium, manganese, selenium, copper, iodine, magnesium, molybdenum, zinc, phosphorus, and combinations thereof.

Useful amino acids include, e.g., L-tyrosine, isoleucine, ornithine, glutamine, phenylalanine, leucine, lysine, methionine, threonine, taurine, tryptophan, valine, alanine, glycine, arginine, histidine, cysteine, asparagine, proline, serine, carnitine, creatine, and aspartate, and derivatives thereof, and combinations thereof.

Useful botanicals include, e.g., ashwagandha, elderberry, cranberry, mushroom varieties, sage, red clover, apple cider vinegar, echinacea, Ginkgo biloba, and combinations thereof.

Other dietary supplements include, e.g., bee pollen, bran, wheat germ, kelp, cod liver oil, ginseng, fish oils, proteins, and combinations thereof.

The gummy composition optionally includes sweetener including, e.g., artificial sweetener (e.g., acesulfame potassium, allulose aspartame, neotame, saccharine, sucralose, and combinations thereof), natural sweetener (e.g., mogrosides (e.g., extracts of monk fruit (Siraitia grosvenorii)), steviol glycosides (e.g., extracts of Stevia rebaudiana), and combinations thereof. When present, the gummy composition optionally includes from 0.001% by weight to 3% by weight, from 0.005% by weight to 1% by weight, or even from 0.01% by weight to 0.1% by weight sugar-free sweetener.

Mono and disaccharides (e.g., sucrose, lactose, maltose, and maltodextrins) may be present in the gummy composition as components in various ingredients of the gummy composition including, e.g., the gelling agent (e.g., pectin), the fructo-oligosaccharides, and any added fruit juice. Preferably the gummy composition is free from added monosaccharides and disaccharides. Added monosaccharides and disaccharides are monosaccharides and disaccharides from sources other than the gelling agent, the fructo-oligosaccharides and fruit juices. For reduced sugar gummy compositions, the total amount of monosaccharide and disaccharide present in the gummy composition preferably is less than 20% by weight, from 0% by weight to no greater than 20% by weight, no greater than 15% by weight, no greater than 10% by weight, or even no greater than 5% by weight. Preferably the reduced sugar chewable gummies include less than 500 mg, less than 400 mg, less than 300 mg, less than 275 mg, less than 250 mg, less than 225 mg of monosaccharides and disaccharides. Alternatively, the gummy composition can optionally include added monosaccharide, disaccharide, and combinations thereof in any amount including from 1% by weight to 90% by weight.

The gummy composition optionally includes sugar alcohol, e.g., erythritol, inositol, isomalt, mannitol, maltitol, sorbitol, xylitol, and combinations thereof, but preferably is free of such sugar alcohols. The gummy composition preferably is free of sugar alcohol but alternatively includes sugar alcohol in any amount including less than 20% by weight, from 0% by weight to no greater than 20% by weight, no greater than 15% by weight, no greater than 10% by weight, or even no greater than 5% by weight.

The gummy composition optionally includes a coating. Useful coatings include, e.g., starch (e.g., corn starch, tapioca starch, potato starch, wheat starch, thin-boiling starch, high amylose corn starch, instant starches, derivatives thereof, and combinations thereof), crystal sugar, wax, and combinations thereof.

The chewable gummy preferably is not tacky to the touch when stored at room temperature (i.e., from 22 °C to 25 °C) and 30% relative humidity for a period of one week, one month, three months or even six months. The chewable gummy preferably maintains its integrity when exposed to elevated temperatures and preferably is free from melting when exposed to 38 °C, 50 °C, or even 60 °C and 30% humidity for a period of 30 minutes. The chewable gummy can be formulated and processed to exhibit any suitable gumminess including a gumminess of from 1.5 Newtons per centimeter² (N/cm²) to 25 N/cm², from 5 N/cm² to 17 N/cm², from 5.8 N/cm² to 16.9 N/cm², or even from 7.2 N/cm² to 14 N/cm² when tested according to the Gumminess Test Method.

### Method of Making

The chewable gummy can be produced using any suitable method. Pectin can degrade when exposed to elevated temperatures for prolonged periods of time. Methods of making chewable gummies that include pectin as a gelling agent preferably are conducted at sufficiently low temperatures or for sufficiently short periods of time so as not to degrade temperature sensitive gelling agents (e.g., pectin).

One useful method of making the chewable gummy includes combining a portion of solid powder fructo-oligosaccharide and gelling agent (e.g., pectin), mixing the ingredients to form a uniform powder mixture, adding liquids (e.g., water and liquid fructo-oligosaccharide) to the uniform powder mixture, homogenizing the mixture, and adding additional portions of the powder fructo-oligosaccharide with mixing to form a homogenized composition. This base composition (e.g., solution) is then heated until a desired brix value is achieved (e.g., from 70 brix to 80 brix). Then, additional ingredients such as fruit juice, flavor and actives can be added and the composition with mixing to form a liquid gummy composition. Then the liquid gummy composition is combined with volatile flavor, color and food acid to bring the gummy composition to a pH range suitable for forming a gel at reduced temperatures (e.g., from 15 °C to 80 °C).

The mixture optionally is transferred to a mold using conventional gummy candy molding methods (e.g., starch molds, Teflon coated molds, and silicone molds), to form a desired shaped chewable gummy.

After the chewable gummy is removed from the mold, a coating (e.g., continuous or discontinuous coating) optionally is applied to the surface of the chewable gummy. The coating composition can be any suitable composition including, e.g., wax, oil, fat, brightener, granulated sugar, acidulant, powdered obrato, starch, powdered calcium, powdered magnesium, and combinations thereof (e.g., carnauba wax and coconut oil emulsion).

The invention will now be described by way of the following examples. All parts, ratios, percents and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20 °C to about 25 °C) unless otherwise specified.

### Gumminess Test Method

The gumminess of a chewable gummy is determined according to the Imada Texture Profile Analysis using a Imada Texture Analyzer Model FRTS-11, or equivalent, and a 100 mm probe shaft and a 20 mm diameter disk probe attachment. The test is conducted by pressing the probe at a rate of 0.5 mm per second (mm/sec) from a starting position at the surface of the sample into the depth of the sample to a distance of ⅔ of its original height (the compression cycle), returning the probe to the starting position at a rate of 0.5 mm/sec (the return cycle), allowing the probe to rest for one second, and then repeating the compression cycle and return cycle using the same conditions. The peak force at the first peak is measured and reported as the hardness in units of grams force (gforce). The cohesiveness is calculated as the area of the second peak divided by the area of the first peak. The gumminess is calculated as the hardness (H) times the cohesiveness (C) (i.e., H×C=gumminess) and is reported in units Newtons per centimeter² (N/cm²).

### Percent Dietary Fiber Test Method

The percent total dietary fiber in a gummy is determined according to the Eurofins Food Chemistry Testing Madison, Inc. (Eurofins) 2023 percent total dietary fiber in a gummy test method, which includes use of the Official Methods of Analysis, Method 2011.25, AOAC International (as modified by Eurofins) for determining total insoluble dietary fiber and Official Methods of Analysis, Methods 2009.01 and 2011.25, AOAC International (as modified by Eurofins) for determining total soluble dietary fiber.

### Example 1

Chewable gummies can be prepared according to the following method using the following ingredients in the amounts specified in Table 1 with mixing. A dry blend is prepared by combining, with mixing, the 1FOS powder fructo-oligosaccharide and the pectin to form the dry blend. The dry blend is combined with the first aliquot of purified water and blueberry juice concentrate, and then homogenized. Then the 2FOS powder fructo-oligosaccharide and the FRUTALOSE SL85 liquid fructo-oligosaccharide are added to the liquid mixture and blended to form a solution. The solution is heated until the mixture reaches 75 Brix. Then the following ingredients are added to the mixture with mixing: folic acid, niacinamide, ascorbic acid, zinc citrate dihydrate, dimagnesium malate, the second aliquot of purified water, 5-HTP (Griffonia simplicifolia extract), cholecalciferol (2.5 weight % in oil), pyridoxine hydrochloride, medium chain triglyceride (MCT) Oil, 95 weight % Rebaudioside M (i.e., Stevia Extract), and flavors (including flavor maskers). Then, citric acid, malic acid, and the third aliquot of purified water are blended together until solubilized to form a solution, which is then added to the existing mixture with mixing.

The resulting gummy composition is then poured into a mold according to a conventional method, cooled, solidified, and then removed from the mold. A suitable amount of polishing composition and tapioca starch is then applied to the surfaces thereof. The gummies are then dried at 50 °C and 30% relative humidity for from 24 hours to 48 hours.

The resulting coated, chewable gummies are expected to have a mass of about 2.5 grams per piece, a diameter of about 20 mm, and a thickness of about 10 mm.

### Examples 2 and 3

The gummy compositions of Examples 2 and 3 can be prepared according to the method described above with respect to Example 1 with the exception that the ingredients and amounts are as set forth in Table 1 below.

### Example 4

Chewable gummies were prepared according to the following method using the following ingredients in the amounts specified in Table 1 with mixing. A kettle was filled with the first aliquot of purified water. The water was then heated to a boil. A dry blend was prepared by combining, with mixing, the 1FOS fructo-oligosaccharide powder and the pectin. The dry blend was then added to the purified water and with mixing to form a blend. Mixing continued until the process was complete. The 2FOS fructo-oligosaccharide powder was then slowly added to the liquid mixture in the kettle. Blueberry juice concentrate and FRUTALOSE SL85 liquid fructo-oligosaccharide were then added to the liquid mixture. The liquid mixture was cooked until the mixture reached 76% Brix.

In a separate vessel a mixture was prepared by combining the ashwagandha extract, the Gamma-aminobutyric acid, the lemon balm extract, and the second aliquot of purified water. This mixture was then added to the cooked liquid mixture.

In another vessel, the medium chain triglyceride (MCT) oil was added to the vessel. Then a mixture was prepared by combining the melatonin and the L-tryptophan. This mixture was then added to the MCT oil. The resulting mixture was then added to the cooked liquid mixture.

Then flavor agents were added to the cooked liquid mixture.

Then the rebaudiosid M, and a mixture of the citric acid, the malic acid, and the third aliquot of purified water were added to the cooked liquid mixture.

The resulting gummy composition was then poured into a mold according to a conventional method, cooled, solidified, and then removed from the mold. A suitable amount of polishing composition and tapioca starch was then applied to the surfaces thereof. The gummies were then dried at 50 °C and 30% relative humidity for from 24 hours to 48 hours.

The resulting coated, chewable gummies had a mass of about 3.7 grams per piece, a diameter of about 20 mm and a thickness of about 10 mm.

TABLE 1

| | Example 1 | Example 2 | Example 3 | Example 4 |
|---|---|---|---|---|
| 1 FOS | 7.647 | 7.685 | 7.556 | 7.672 |
| Pectin | 2.291 | 2.382 | 2.267 | 2.378 |
| Water | 25.197 | 22.686 | 24.934 | 22.648 |
| Blueberry Juice | 4.581 | 4.764 | 4.533 | 4.756 |
| Concentrate | | | | |
| 2 FOS | 25.972 | 27.224 | 25.689 | 27.178 |
| FRUTALOSE | 26.477 | 27.507 | 26.193 | 27.461 |
| SL85 | | | | |
| Ashwagandha | 0.00 | 1.843 | 0.00 | 1.840 |
| Extract | | | | |
| GABA | 0.00 | 0.347 | 0.00 | 0.347 |
| Melatonin | 0.00 | 0.174 | 0.00 | 0.173 |
| L-Tryptophan | 0.00 | 0.174 | 0.00 | 0.173 |
| Lemon Balm | 0.00 | 0.029 | 0.00 | 0.029 |
| Extract | | | | |
| Folate | 0.00 | 0.00 | 0.001 | 0.00 |
| Folic Acid | 0.001 | 0.00 | 0.00 | 0.00 |
| Niacinamide | 0.035 | 0.00 | 0.026 | 0.00 |
| Ascorbic Acid | 0.139 | 0.00 | 0.137 | 0.00 |
| Zinc Citrate | 0.043 | 0.00 | 0.042 | 0.00 |
| Dihydrate | | | | |
| Dimagnesium | 1.145 | 0.00 | 1.440 | 0.00 |
| Malate | | | | |
| Vitamin B6 | 0.00 | 0.00 | 0.003 | 0.00 |
| Water | 1.145 | 0.851 | 1.079 | 0.849 |
| 5-HTP | 0.539 | 0.00 | 0.529 | 0.00 |
| Cholecalciferol | 0.001 | 0.00 | 0.001 | 0.00 |
| Pyridoxine HCl | 0.003 | 0.00 | 0.00 | 0.00 |
| MCT Oil | 0.505 | 0.425 | 0.518 | 0.425 |
| Flavor | 0.612 | 1.753 | 0.604 | 1.750 |
| Stevia Extract | 0.031 | 0.028 | 0.030 | 0.028 |
| Citric Acid | 1.213 | 0.709 | 1.197 | 0.708 |
| Malic Acid | 0.606 | 0.354 | 0.598 | 0.354 |
| Water | 1.819 | 1.063 | 1.795 | 1.062 |
| Total Dietary | ND | 49.3 | ND | 49.3 |
| Fiber | | | | |

1 FOS and 2 FOS = fructo-oligosaccharide 95 powder (Baolingbao Biology Co., Ltd., Yucheng Shandong, China)
Pectin = (International Flavors and Fragrances Inc., New York, New York)
FRUTALOSE SL85 = liquid fructo-oligosaccharide having a degree of polymerization from 3 to 20, 84% to 88% oligofructose (dry weight basis), 12% to 16% sugar (fructose, glucose, sucrose) (dry weight basis), 63 g/100 g dietary fiber, and 12 g/100 g sugar (Royal Cosun,
GABA = gamma-amino butyric acid
5-HTP = 5-hydroxytryptophan
Cholecalciferol = 2.5% by weight cholecalciferol in oil
Total Dietary Fiber = the % by weight dietary fiber present in the gummy

Other embodiments are within the claims. Documents referred to herein are incorporated to the extent they do not conflict.

1. A method of making a chewable gummy, the method comprising:
forming a gummy composition by combining
liquid fructo-oligosaccharide having a Brix of at least 25%,
powder fructo-oligosaccharide,
pectin,
water, and
food acid; and
allowing the gummy composition to set to form a chewable gummy.

2. The method of claim 1, wherein the liquid fructo-oligosaccharide has a first average degree of polymerization, the powder fructo-oligosaccharide has a second average degree of polymerization, the second average degree of polymerization being greater than the first average degree of polymerization.

3. The method of claim 1 further comprising:
combining a first portion of the powdered fructo-oligosaccharide and the pectin;
mixing the powdered fructo-oligosaccharide and the pectin to form a first uniform mixture;
combining the first uniform mixture and water to form an aqueous composition; and
subsequently adding the liquid fructo-oligosaccharide to the aqueous composition.

4. The method of claim 3, wherein the method further comprises combining, with mixing, a second portion of the powder fructo-oligosaccharide and the liquid fructo-oligosaccharide prior to the step of adding the liquid fructo-oligosaccharide to the aqueous composition.

5. The method of claim 1, wherein the resulting chewable gummy comprises greater than 20% by weight dietary fiber.

6. The method of claim 1 further comprising:
combining the water and the liquid fructo-oligosaccharide to form a first composition;
adding the powdered fructo-oligosaccharide to the first composition to form a second composition;
homogenizing the second composition to form a homogenized liquid; and
subsequently adding pectin to the homogenized liquid.

7. The method of claim 1, wherein the liquid fructo-oligosaccharide has a Brix of at least 60%.

8. A chewable gummy made according to the method of claim 1.

9. The method of claim 1, wherein the fructo-oligosaccharides, taken in combination,
have an average degree of polymerization no greater than 11,
a mode degree of polymerization no greater than 11, and
contribute at least 20% by weight dietary fiber to the chewable gummy.

10. The method of claim 1, wherein
the liquid fructo-oligosaccharide has an average degree of polymerization no greater than 10, and
the powder fructo-oligosaccharide has an average degree of polymerization no greater than 20.

11. The method of claim 1, wherein the liquid fructo-oligosaccharide and the powder fructo-oligosaccharide exhibit a bimodal molecular weight distribution, a bimodal degree of polymerization distribution, or a combination thereof.

12. The method of claim 1, wherein the powder fructo-oligosaccharide has a mode degree of polymerization that is greater than the mode degree of polymerization of the liquid fructo-oligosaccharide.

13. The method of claim 1 comprising combining
from 10% by weight to 80% by weight of the liquid fructo-oligosaccharide,
from 10% by weight to 80% by weight of the powder fructo-oligosaccharide, and
from 1% by weight to 5% by weight of the pectin.

14. The method of claim 1, wherein the ratio of the powder fructo-oligosaccharide to the liquid fructo-oligosaccharide is from 50:50 to 65:35.

15. The method of claim 1, wherein the percent by weight powder fructo-oligosaccharide in the gummy composition is greater than the percent by weight of the liquid fructo-oligosaccharide in the gummy composition.

16. The method of claim 1, wherein the gummy composition further comprises from 0 mg to less than 250 mg of a sugar selected from the group consisting of monosaccharides, disaccharides, and combinations thereof.

17. The method of claim 1, wherein the chewable gummy comprises
from 50% by weight to 90% by weight fructo-oligosaccharides, and
from 1% by weight to 5% by weight pectin.

18. The method of claim 1, wherein the resulting chewable gummy comprises from 75% by weight to 90% by weight fructo-oligosaccharides.

19. The method of claim 1, wherein the resulting chewable gummy is sugar free.
